(19) United States
(12) Patent Application Publication
(10) Pub. No.: US 2006/0081410 A1
(43) Pub. Date: Apr. 20, 2006

(54) Force-based power steering system

(76) Inventor: Edward H. Phillips, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/252,989

(22) Filed: Oct. 18, 2005

Related U.S. Application Data
(60) Provisional application No. 60/620,079, filed on Oct. 18, 2004.

(51) Int. Cl. B62D 5/06

(52) U.S. Cl. 180/421

(57) ABSTRACT

A power steering system includes a double-acting power cylinder having a four-way valve for controlling steering direction. An accumulator stores pressurized fluid that is controllably supplied to the four-way valve by an electronically controlled three-way valve based upon an applied torque measured at a steering wheel.

This application claims priority to U.S. Provisional Application Ser. No. 60/620,079 filed Oct. 18, 2004.

### BACKGROUND OF THE INVENTION

The present invention relates generally to power steering systems for vehicles, and more particularly to an energy efficient power steering system intended particularly for medium to large vehicles.

Virtually all present power steering systems comprise implementation means whose fundamental output is force based. By way of example, present art power steering systems generally comprise an open-center four-way valve that delivers differential pressure to a double-acting power cylinder as a function of torque applied to a steering wheel. This is accomplished via torque applied to the steering wheel progressively closing off return orifices comprised within the open-center four-way valve. Another example is an electric power steering system (hereinafter ‘“EPS system”) wherein a servomotor delivers torque to the steering gear as a function of current applied to it by a controller. An EPS system of particular interest herein is described in U.S. Pat. No. 6,152,254, entitled “Feedback and Servo Control for Electric Power Steering System with Hydraulic Transmission,” issued Nov. 28, 2000 to Edward H. Phillips, wherein differential pressure is directly delivered to a double-acting power cylinder from a servomotor driven reversible fluid pump. In view of continued reference hereinbelow to the '254 patent, the whole of that patent is also expressly incorporated in its entirety by reference herein.

While the EPS system described in the incorporated '254 patent has optimum performance characteristics, it like all EPS systems is limited in utilization to relatively small vehicles because of limited available electrical power. All vehicle manufacturers limit electrical current availability for EPS systems to a value that can be supplied directly from an alternator. A limiting value of perhaps 70 Amperes from a 12 Volt electrical system is typical. At a lower limiting voltage value of 10 Volts and an overall EPS system efficiency of perhaps 60 percent this results in a net maximum power delivery from the steering gear of only 420 Watts. This low value stands in stark contrast to known future power steering system requirements ranging as high as 3,500 Watts.

Various so-called “closed-center” power steering systems have been proposed as a solution to this problem. Such closed-center power steering systems utilize an accumulator to store power steering fluid at relatively high pressure. Some form of closed-center valving is then used to meter a flow of pressurized fluid to one end of a double-acting power cylinder while concomitantly permitting a similar return flow of low-pressure fluid from the other end thereof to a reservoir. Generally, pressurized fluid is supplied to the accumulator from the reservoir by a relatively small displacement pump driven by a simple (e.g., non-servo) motor controlled by a pressure-activated switch.

To date however, none of the proposed closed-center power steering systems has provided acceptable on-center steering “feel” and they have not gained acceptance in the industry. It is believed herein that the primary problem with the closed-center power steering systems proposed to date is that their fundamental output is fluid flow or rate-based rather than force-based as is described above with reference to currently accepted power steering systems. The fundamental problem with the rate-based closed-center systems is that they provide nominally linear control of system velocity with inherent discontinuities in system acceleration. It is believed herein that these discontinuities in system acceleration are the root cause of the unacceptable on-center steering feel in the closed-center power steering systems. By way of contrast, all force-based systems provide direct quasi-linear control of system acceleration.

Therefore, it would be highly advantageous to provide an accumulator enabled power steering system that has the acceptable on-center steering “feel” provided by a force-based power steering system. Such a force-based power steering system was disclosed in U.S. Pat. No. 6,945,352 entitled “FORCE-BASED POWER STEERING SYSTEM,” issued Sep. 20, 2005 to Edward H. Phillips, which is hereby incorporated by reference in its entirety. Since the application for that patent was filed however, some have suggested that they would prefer a system with improved failsafe characteristics wherein unwanted steering forces are not possible regardless of failure mode.

### SUMMARY OF THE INVENTION

An accumulator enabled power steering system according to the present invention functions as a force-based power steering system in an inherently failsafe manner.

The accumulator enabled power steering system of the present invention includes a directional control open-center four-way valve having an input port, a return port fluidly connected to a reservoir, and left and right output ports respectively fluidly connected to left and right cylinder ports of a power cylinder. An electronically controlled slightly over-lapped normally open three-way valve has an input port fluidly connected to an accumulator and a return port fluidly connected to the reservoir. An output port of the three-way valve is fluidly connected to the input port of the four-way valve. A valve spool in three-way valve is spring-loaded in accordance with the three-way valve's designation of being “normally open” such that the output port and therefore the input port of the four-way valve are normally fluidly connected to its return port and therefore the reservoir.

A steering wheel torque transducer provides an applied torque signal Vₐₜ indicative of values of torque applied to the steering wheel (hereinafter “applied torque”). A pressure transducer provides a pressure signal Vₚ indicative of pressure values present at the input port of the directional control open-center four-way valve. A controller provides a power control signal V_{c} to the three-way valve at values determined via filtering and amplifying an error signal Vₑ. The error signal Vₑ is generated by the difference between a control function signal V_{cf} determined by a control algorithm from at least the applied torque signal Vₐₜ and the pressure signal Vₚ issued by the pressure transducer. The power control signal V_{c} is for controlling the three-way valve such that pressurized fluid is supplied to the input port of the four-way valve at fluid pressure values that continually reduce the error signal Vₑ. Thus, pressurized fluid is provided by the four-way valve to one of the ports of the double-acting power cylinder as determined by the rotational direction of the applied torque at a value in accordance with the magnitude of the applied torque and the resulting control algorithm determined control function signal V_{cf}.

The accumulator is initially and then intermittently charged with fluid such that the accumulator fluid pressure is always greater than a selected threshold value exceeding that required for executing any likely steering load. Operationally, whenever torque is applied to the steering wheel, an applied torque signal Vₐₜ is sent to the controller by the torque transducer. First, the absolute value of the applied torque signal Vₐₜ is multiplied by a control function constant K_{cf} to form the control function signal V_{cf}, wherein the control function constant K_{cf} is determined by the above mentioned control algorithm as a selected function of the applied torque value, and in addition, most likely at least the vehicular speed in accordance with procedures fully explained in the incorporated '254 patent. The pressure signal Vₚ from the pressure transducer is then subtracted from the control function signal V_{cf} whereby the resulting algebraic sum forms the error signal Vₑ. The error signal Vₑ is then filtered and amplified to form the power control signal V_{c} that is then used to control the three-way valve such that appropriately pressurized fluid is provided to the appropriate power cylinder port as directed by the directional control open-center four-way valve in accordance with the rotational direction of the applied torque. Thus, steering force is applied to the dirigible (steerable) wheels of the host vehicle in accordance with the rotational direction and magnitude of the applied torque. Such three-way slightly over-lapped servo valves and their operative characteristics are thoroughly described in a book by Herbert E. Merritt entitled “Hydraulic Control Systems” and published by John Wiley & Sons, Inc. of New York.

It is desirable for working pressures in the double-acting power cylinder to always be kept at the lowest pressure values possible. This keeps pressure values applied to various power cylinder seals to a minimum thereby reducing leakage problems and minimizing Coulomb friction. The directional control open-center four-way valve, wherein at least one of the left and right output ports is always fluidly connected to return port and thus the reservoir, automatically accomplishes this task of course. In addition however, it is also desirable to fluidly couple both of the left and right cylinder ports to the reservoir during “on-center” steering conditions. This improves overall system efficiency by allowing small on-center steering motions to be effected without using any accumulator-sourced fluid. In the accumulator enabled power steering system of the present invention this is automatically accomplished by configuring the control algorithm such that the control function constant K_{cf} has zero values for small near on-center values of applied torque. This in turn results in the normally open slightly over-lapped three-way servo valve having zero valued power control signals for small near on-center values of torque applied to the steering wheel whereby both cylinder ports are fluidly connected to the reservoir.

A primary failsafe shutdown procedure is implemented via precluding current from being applied to the three-way valve whereby the spring-loaded valve spool again causes its output port and therefore the input port of the directional control open-center four-way valve to be fluidly connected to the reservoir thus imposing manual steering regardless of steering load. Furthermore, a redundant failsafe feature is provided via the four-way valve directly controlling fluid flow to the ports of the power cylinder in the manner of the present power steering systems mentioned above.

Overall system accuracy and stability is provided during normal operation via a feedback control loop implemented with reference to the pressure signal Vₚ representative of actual fluid pressure values present at the input port of the directional control open-center four-way valve. Because this type of control technique is described in detail in the incorporated '254 patent, it will not be repeated in full detail herein.

Because of its improved steering feel and ability to service known future power steering systems whose net hydraulic power requirements range as high as 3,500 Watts, a power steering system configured according to the present invention possesses distinct advantages over known prior art power steering systems able to handle such large steering loads. For example, the power steering system of the present invention provides dramatically improved system efficiency when compared to standard hydraulic power steering systems utilizing engine driven pumps. Further, the power steering system of the present invention provides dramatically improved tactile feel when compared to known prior art accumulator and closed-center valve enabled power steering systems. Thus, the accumulator enabled power steering system of the present invention enables both efficient and tactilely acceptable power steering for medium to large vehicles.

### BRIEF DESCRIPTION OF THE DRAWINGS

Other advantages of the present invention can be understood by reference to the following detailed description when considered in connection with the accompanying drawings wherein:

FIG. 1 is a combined isometric and schematic view of a portion of a host vehicle that comprises the accumulator enabled power steering system of the present invention;

FIG. 2 is a sectional view of a three-way slightly over-lapped normally open servo valve utilized in the accumulator enabled power steering system of the present invention;

FIG. 3 is a sectional view of a directional control open-center four-way valve utilized in the accumulator enabled power steering system of the present invention;

FIG. 4 is a graphical representation of flow delivery and return characteristics of the three-way slightly over-lapped normally open servo valve depicted in FIG. 2;

FIG. 5 is a sectional view of a portion of a steering wheel motion direction sensor utilized in the accumulator enabled power steering system of the present invention;

FIGS. 6A AND 6B are combined isometric and schematic views of alternate apparatus for providing pressurized fluid to an accumulator comprised in the accumulator enabled power steering system of the present invention;

FIG. 7 is a block diagram representing various mechanical, hydraulic and electronic connections and relationships existing in any host vehicle comprising the accumulator enabled power steering system of the present invention; and

FIG. 8 is a flow chart depicting a method of control for the accumulator enabled power steering system of the present invention.

### DETAILED DESCRIPTION OF THE PREFERRED EMBODIMENTS

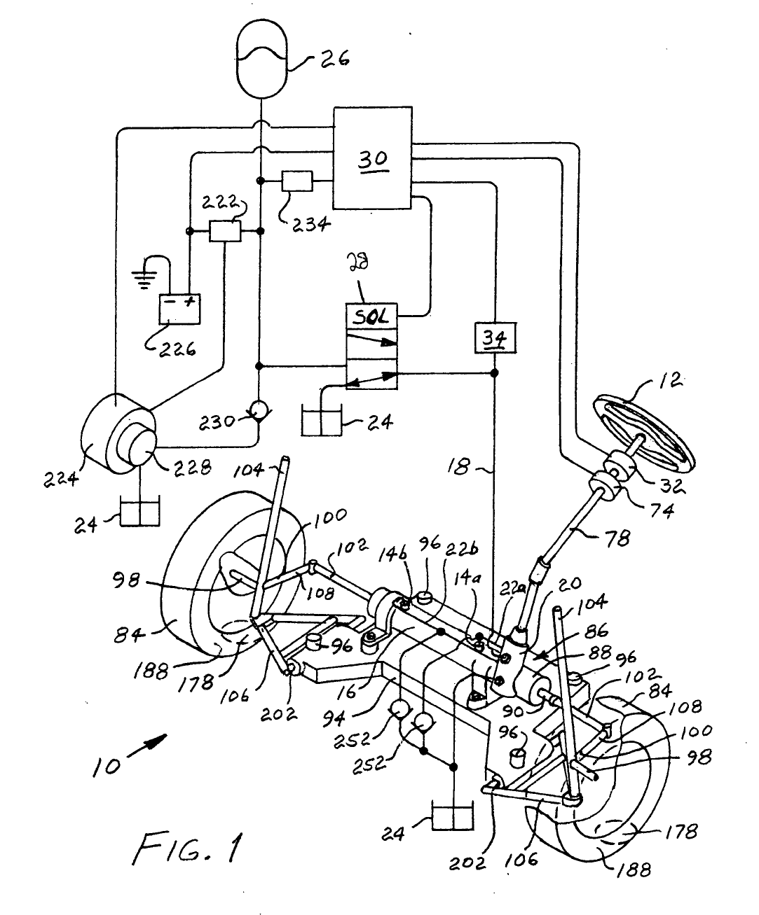

The present invention is directed to simplified method and apparatus for enabling an accumulator enabled power steering system to function in the manner of a force-based power steering system. With reference first to FIGS. 1, 2 and 3, there shown in perspective, schematic and sectional views are operative elements of an accumulator enabled power steering system 10 wherein torque applied by a driver to a steering wheel 12 results in pressurized fluid being conveyed to or from one of a left cylinder port 14a and a right cylinder port 14b of a double-acting power cylinder 16 via a fluid line 18, a directional control open-center four-way valve 20, and one of respective left turn tube 22a and right turn tube 22b, with low pressure (hereinafter “reservoir pressure”) fluid being conveyed from or to the other one of the left cylinder port 14a and the right cylinder port 14b via the other one of the left turn tube 22a and the right turn tube 22b, the directional control open-center four-way valve 20 and on to a reservoir 24. In order to maintain the pressurized fluid conveyed to or from the directional control open-center four-way valve 20 at selected pressure levels, controlled amounts of pressurized fluid issuing from an accumulator 26 or returning to the reservoir 24 via the fluid line 18 are metered to or from the fluid line 18 via a three-way valve 28. The three-way valve 28 is electronically controlled in response to a power control signal V_{c} issuing from a controller 30. The three-way valve 28 is preferably a slightly over-lapped, normally open, servo valve, but other configurations may be utilized. To clarify the presentation of the various connections to the reservoir 24, the reservoir 24 is shown in FIG. 1 at a plurality of locations. All of these constitute the same reservoir 24 however, not separate reservoirs.

The accumulator 26 is initially and then intermittently charged with pressurized fluid such that the accumulator fluid pressure is greater than a selected threshold value exceeding that required for meeting any likely steering load. Operationally, whenever torque is applied to the steering wheel 12, an applied torque signal Vₐₜ is sent to the controller 30 by a torque transducer 32 operatively connected thereto. Then as will be further described below, the absolute value of the applied torque signal Vₐₜ is multiplied by a control function constant K_{cf} to form a control function signal V_{cf}, where the control function constant K_{cf} is generated by the controller 30 as a function of at least the applied torque value, and most probably vehicular speed, in accordance with procedures fully explained in the incorporated '254 patent. A pressure signal Vₚ from a pressure transducer 34 provided for measuring pressure values in the fluid line 18 is then subtracted from the control function signal V_{cf} whereby the resulting algebraic sum forms an error signal Vₑ. The error signal Vₑ is then filtered and amplified to form a power control signal V_{c} that is then continuously applied to the three-way valve 28 in such a manner as to cause the error signal Vₑ to decrease in value. As will be further described hereinbelow, it is desirable for the control function constant K_{cf} generated by the controller 30 to have a zero value to relatively low initiating values of applied torque (i.e., +/−7.5 in.lbs.) and then blend into a selected linear control characteristic over perhaps twice that range in order to effect a preferred on-center steering characteristic.

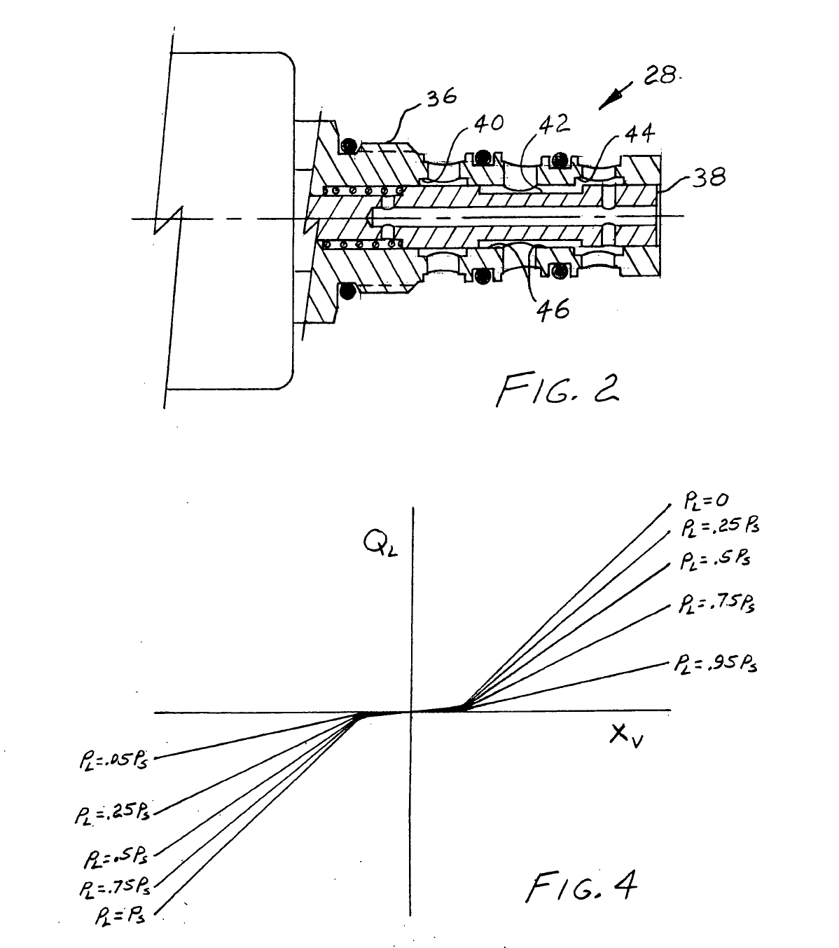

With particular reference now to FIG. 2, the three-way valve 28 comprises a valve sleeve 36 and a spring-loaded valve spool 38. As is conventional, the valve sleeve 36 and spring-loaded valve spool 38 are configured with a slightly over-lapped set of grooves and lands including an input groove 40, an output groove 42 and a return groove 44, wherein the output groove 42 is formed with slightly less axial length than that of the land 46 separating the input groove 40 and the return groove 44. As explained in detail in the book entitled “Hydraulic Control Systems,” forming the three-way valve 28 in a practical slightly over-lapped manner results in it issuing a flow of pressurized fluid in a linear manner with reference to positions of the spring-loaded valve spool 38 in either flow delivery or flow return modes as well as in a continuous manner at reduced slope through its valve null position.

With particular reference now to FIG. 3, the directional control open-center four-way valve 20 is there shown in an on-center position. The directional control open-center four-way valve 20 comprises a valve sleeve 48 and an input shaft 50 compliantly affixed one to another in a normal manner via a torsion bar 52, wherein one end of the torsion bar 52 is affixed to a pinion (not shown) and the other end is affixed to the input shaft 50. For convenience, the pinion will hereinafter be referred to as “the pinion 54” because of continued reference made thereto hereinbelow. And again as normal, the valve sleeve 48 is constrained for rotation with the pinion 54 via a single radial pin (also not shown).

As a design choice, either one of the valve sleeve 48 and input shaft 50 comprises multiple input slots 56 and return slots 58 while the other one of the valve sleeve 48 and input shaft 50 comprises multiple left output slots 60a and right output slots 60b (i.e., as depicted in FIG. 3, the valve sleeve 48 comprises the input slots 56 and return slots 58 while the input shaft 50 comprises the left output slots 60a and right output slots 60b). In addition, input holes 62, left output holes 64 and right output holes 66 are formed in the valve sleeve 48 for respectively conveying fluid to or from circumferential grooves 246 formed in the periphery of the valve sleeve 48 and thence through ports of a valve housing (neither shown) to the fluid line 18, left turn tube 22a and the right turn tube 22b. Return holes 248 are formed into a bore 250 of the input shaft 50 and from there are fluidly connected to the reservoir 24 via a housing port and return line (neither shown).

The directional control open-center four-way valve 20 is formed in an open-center manner as a consequence of the input slots 56 and return slots 58, and left output slots 60a and right output slots 60b all being formed with greater widths than juxtaposed lands 68 whereby input orifices 70a and 70b, and return orifices 72a and 72b are all enabled for freely conveying fluid in the on-center position as illustrated in FIG. 3. In order to conserve pressurized fluid however, it is necessary to configure the various slots such that either set of input orifices 70a and return orifices 72b, or input orifices 70b and return orifices 72a close simultaneously at substantially the initiating values of applied torque as defined above with respect to the control function constant K_{cf}. By way of example, if the torsion bar 52 has a torsional stiffness of 300 in.lbs./rad., the input shaft 50 has a radius of 0.400 in., and the orifice closing torque value is chosen to be 7.5 in.lbs.; then the resulting on-center circumferential width of the orifices 70a, 70b, 72a and 72b is 0.010 in. As a design choice, it may be desirable to configure the left output slots 60a and right output slots 60b in either a circumferentially angled or tapered manner as both shown in U.S. Pat. No. 5,353,593 entitled “Bootstrap Hydraulic Systems,” in order to effect a smooth transition to power assisted steering.

Optimum performance of the three-way valve 28 can be obtained by optimizing its flow gain. As depicted in FIG. 4 however, the slopes of flow delivery and flow return curves are in general different on either side of their valve null positions (e.g., other than for the special case where the load pressure P_{L} is exactly half the supply pressure P_{S}). This is because its flow rate is substantially proportional to the product of instant open orifice area and the square root of the instant pressure difference there across. For example, the slope of the delivery flow curve has a maximum value at the beginning of a steering event when the pertinent power cylinder pressure is near reservoir pressure—while the slope of the return flow curve has a minimum value at the end of a steering event as the pertinent power cylinder pressure again decreases to near reservoir pressure.

As further explained in detail in the book entitled “Hydraulic Control Systems,” flow values in either of the delivery flow or return flow directions can be determine by
Q=70w×Sqrt[deltaP]

where Q is flow rate, w is circumference and x instant valve stroke of the spring-loaded valve spool 38, and deltaP is pressure drop across the valve orifice. In addition, stroking force can be found by
F=0.006/Sqrt[deltaP]Q+kx+F₀

where F is the stroking force, and k and F₀ are the spring constant and force associated with the valve null position of the spring-loaded valve spool 38. Finally, the valve flow gains in either direction can be defined as the ratio of flow to variable portions of the stroking force or
K_{q}=Q/(F−F₀)=1/(0.0061Sqrt[deltaP]+k/(70wSqrt[deltaP]))

where K_{q} is valve flow gain. Thus, the flow-sourced portion becomes dominant at high values of pressure drop and the spring rate-sourced portion becomes dominant at low values of pressure drop. This results in minimum valve flow rate gain values occurring at the extremes and larger values perhaps 2 to 3 times larger occurring at moderate pressure drop values in between.

The transition between dissimilar flow delivery and flow return curve slopes is eased however, by virtue of the three-way valve 28 being configured in a slightly over-lapped manner. As depicted in the book entitled “Hydraulic Control Systems,” this would result in a zero slope, and thus zero valve gain, between so bifurcated critical positions of an “ideal” such slightly over-lapped three-way servo valve. This is not the case with a practical slightly over-lapped three-way valve 28 however, because of its finite leakage characteristics. Thus, there is a smooth transition of valve gain through the bifurcated critical position region in the manner depicted in FIG. 4 (wherein the extent of the bifurcated critical position region has been exaggerated for illustrative purposes). Actually, it has been found that this eases the stability criterion for the accumulator enabled power steering system 10 because the most difficult stability problems typically occur during slowly implemented parking maneuvers involving transitions between the bifurcated critical positions. As depicted in FIG. 4, a practical three-way valve 28 effects this maneuver with its valve gain smoothly varying to a low value through the bifurcated critical position region between delivery and return flow conditions.

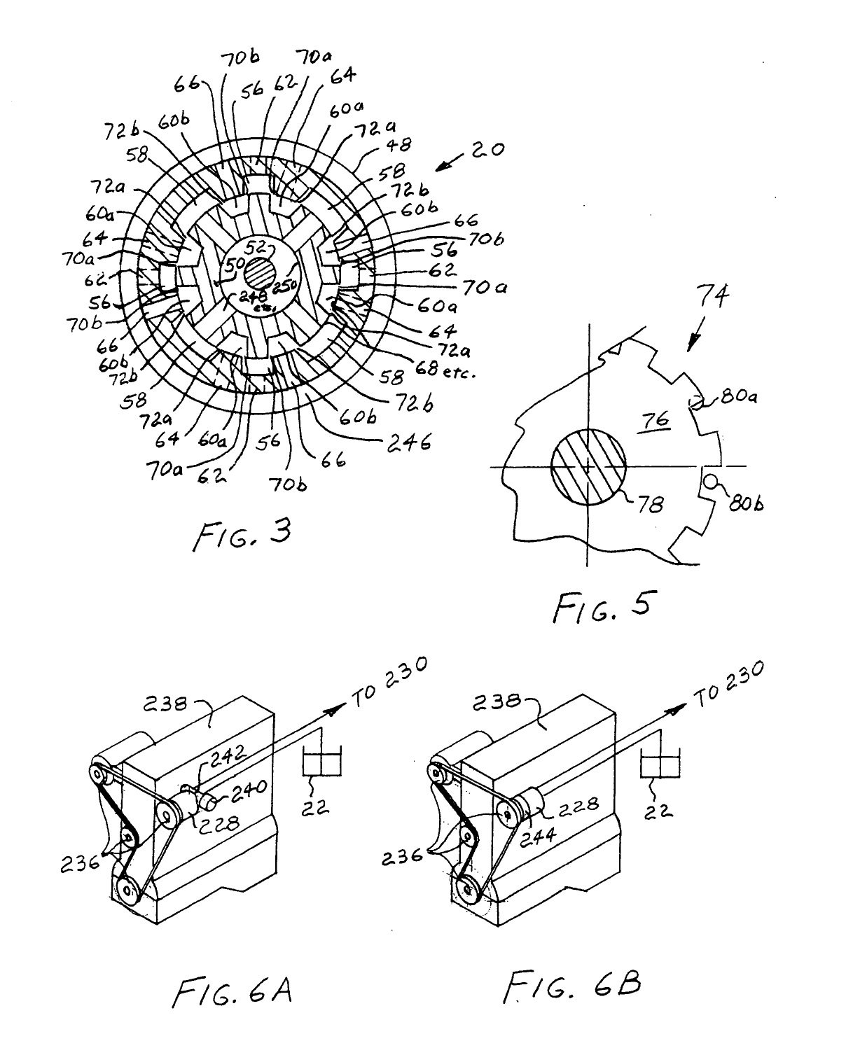

In most cases adequate control can be achieved without tailoring feedback filtering in accordance with instant deltaP values, or alternately, by limited such tailoring achieved through interpretation of which one of the input grooves 40 or return grooves 44 is instantly in use via a combination of signals indicative of solenoid current and output pressure value. However, such tailoring may in some cases be desirable. In such cases, it is necessary to additionally provide the controller 30 with a signal indicative of the direction of fluid flow through the three-way valve 28 in order for it to interpret which of the input groove 40 or return groove 44 is instantly being utilized. This of course requires additional means for determining the direction of fluid flow. Perhaps the easiest way to determine the direction of fluid flow is to take advantage of the obvious correlation between fluid flow direction and steering wheel motion by utilizing a steering wheel motion direction sensor 74 to determine the direction of rotational motion of the steering wheel and then convey a signal so indicative to the controller 30. As shown in FIG. 5, such a steering wheel motion direction sensor 74 comprises a shaft angle encoder disc 76 coupled to the steering wheel 12 via a steering shaft 78 for rotation therewith and sensors 80a and 80b positioned such that they sense the passage of each space 82 in quadrature one-to-another. This technique utilizes one of the sensors 80a or 80b to count the passage of a space 82 while the instant polarity indicated by the other sensor 80b or 80a during that count determines whether it is to be taken in an up or down direction and is of course well known in the electronics industry.

It is desirable for working pressures in the double-acting power cylinder 16 to always be kept at the lowest pressure values possible. This keeps pressure values applied to various power cylinder seals to a minimum thereby reducing leakage problems and minimizing Coulomb friction. The directional control open-center four-way valve 20, wherein at least one set of the left output slots 60a and right output slots 60b is always fluidly connected to the return slots 58 and thus the reservoir 24, automatically accomplishes this task of course.

In addition, it is also desirable to fluidly couple both of the left output slots 60a and right output slots 60b (and thus the left cylinder port 14a and the right cylinder port 14b) to the reservoir 24 during “on-center” steering conditions. This improves overall system efficiency by allowing small on-center steering motions to be effected without using any accumulator-sourced fluid. In the accumulator enabled power steering system 10 this is automatically accomplished by configuring the control algorithm such that the control function constant K_{cf} has zero values for near on-center values of applied torque (i.e., such as +/−7.5 in.lbs.). This in turn results in the normally open slightly over-lapped three-way valve 28 having zero valued power control signals for small near on-center values of torque applied to the steering wheel whereby both the left cylinder port 14a and the right cylinder port 14b are fluidly connected to the reservoir 24.

In the accumulator enabled power steering system 10 a primary failsafe shutdown procedure is implemented via precluding current from being applied to the three-way valve 28 whereby the spring-loaded valve spool 38 again causes its output groove 42 and therefore the fluid line 18 and the input slots 56 of the directional control open-center four-way valve 20 to be fluidly connected to the reservoir 24 thus imposing manual steering regardless of steering load. Furthermore, a redundant failsafe feature is provided via the directional control open-center four-way valve 20 directly controlling fluid flow to the left cylinder port 14a and the right cylinder port 14b of the double-acting power cylinder 16 in the manner of present power steering systems as mentioned above.

A fluid source must of course be provided for charging the accumulator 26 with pressurized fluid. An electrically driven fluid source can be utilized for this purpose as is indicated in alternate forms in FIG. 1. In perhaps the simplest version thereof, pressure-activated switch 222 can be utilized to electrically couple a drive motor 224 to a battery 226 whereby the drive motor 224 drives a pump 228 that then pumps fluid from the reservoir 24 to the accumulator 26 via a check valve 230 and supply line 232. This requires use of a brush-type DC drive motor 224 of course. Alternately, a brushless type of drive motor 224 can be utilized via provision of a pressure sensor 234 sending a signal indicative of the instant supply pressure (e.g., accumulator pressure) to the controller 30 and the controller 30 coupling a brushless type drive motor 224 to the battery 226 via inverter circuitry (not shown). In either case, this continues until a de-activation pressure level is reached whereat the drive motor 224 and pump 228 are stopped. The check valve 230 is then utilized for preventing back flow to the reservoir 24 via leakage through the pump 228.

On the other hand, it may be desired to maintain the supply pressure in the accumulator 26 at a nominally constant value in order to maintain the consistent gain characteristics for the three-way valve 28. In this case, the drive motor 224 is configured as a variable speed drive motor driven by a controlled power signal issuing from the controller 30 such that the drive motor 224 and pump 228 function as part of a relatively simple servo system for maintaining the supply pressure at a preselected nominal value.

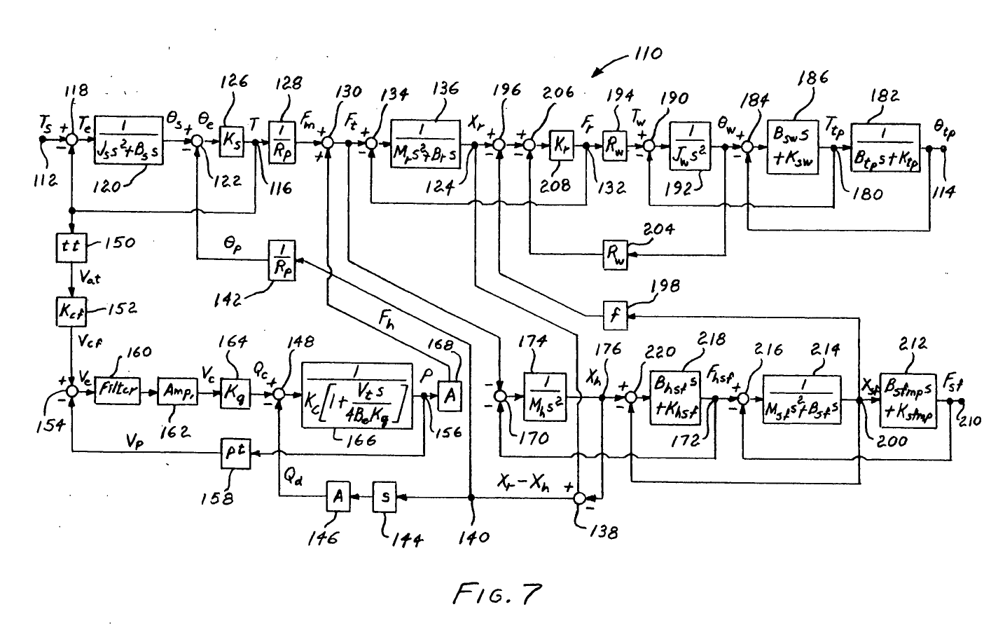

On the other hand, an accessory drive train 236 of the engine 238 of the host vehicle can be directly utilized to mechanically drive the pump 228 in either of the manners depicted in FIGS. 6A and 6B. The required intermittent functional operation of the pump 228 can be accomplished by utilizing an electronically controlled two-way valve 240 for closing a bypass passage 242 in order to force the pumped and thereby pressurized fluid to flow through the check valve 230 as shown in FIG. 6A. Or as depicted in FIG. 6B, an electrically activated clutch 244 similar to those commonly utilized for automotive air conditioning compressors can be used to intermittently couple the accessory drive train 236 to the pump 228.

With reference again to FIG. 1, the accumulator enabled power steering system 10 is there shown in conjunction with various mechanical components of the host vehicle in which the accumulator enabled power steering system 10 is located. More particularly, a driver rotates the steering wheel 12 in order to steer dirigible wheels 84 of the host vehicle. The steering wheel 12 is connected to the dirigible wheels 84 by the steering shaft 78 and a suitable steering gear 86, for example of the rack-and-pinion type, contained in a steering gear housing 88 wherein a rack 90 is mechanically engaged by the pinion 54 as driven by the input shaft 50 and torsionally compliant torsion bar 52.

As is conventional, application of an applied steering torque Tₛ to the steering wheel 12 results in application of an assisted steering force to the dirigible wheels 84. More particularly, the rack 90 is partly contained within a portion of the steering gear housing 88 comprising the double-acting power cylinder 16. The steering gear housing 88 is in turn fixed to a conventional steering assembly sub-frame 94. The steering assembly sub-frame 94 includes a plurality of mounts 96 for connecting the steering assembly sub-frame 94 to the vehicle chassis (not shown). The dirigible wheels 84 are rotatably carried on wheel spindles 98 connected to the rack 90 via steering knuckles 100 and tie rods 102, and pivotally connected to the host vehicle's chassis and/or steering assembly sub-frame 94 via vehicle struts 104 and lower control arms 106. A portion 108 of each steering knuckle 100 defines a knuckle arm radius about which the assisted steering force, comprising both mechanically derived steering force and powered assist to steering as respectively provided by a pinion-rack interface (not shown) and the double-acting power cylinder 16, is applied.

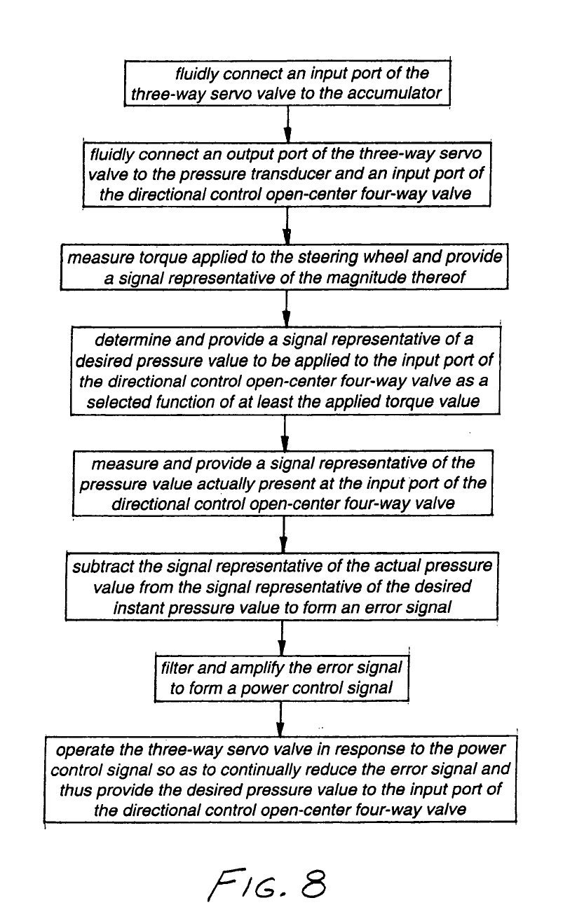

With reference now to FIG. 7, there shown is a block diagram 110 that is helpful in understanding various mechanical and hydraulic connections and relationships existing in the host vehicle. These connections control the dynamic linkage between steering wheel torque Tₛ applied by a vehicle operator to the steering wheel, and the resulting output tire patch steering angle Thetaₜₚ.

The block diagram 110 is also useful in that it allows an assessment of the response to a perturbation arising anywhere between the system input (here, the applied steering wheel torque Tₛ) at input terminal 112 and the system output (here the steering angle or dirigible wheel tire patch angle Thetaₜₚ) at output terminal 114. Therefore, while the block diagram 110 will be described in a forward direction from the input terminal 112 to the output terminal 114 (a direction associated with actually steering the vehicle), concomitant relationships in the other directions should be assumed to be present. However, detailed descriptions of such opposite, concomitant relationships are omitted herein for the sake of brevity.

In any case, an applied steering torque T present at terminal 116 and representative of actual torque applied to the torsion bar 52 is subtracted from Tₛ at a summing point 118. That algebraic sum yields an “error torque” Tₑ, which in this case is the available torque for accelerating the moment of inertia of the steering wheel 12. Tₑ is then divided by (or rather, multiplied by the reciprocal of) the sum of a moment of inertia and damping term (Jₛs²+Bₛs) of the steering wheel 12 at block 120 where Jₛ is the moment of inertia of the steering wheel, Bₛ is steering shaft damping and s is the Laplace variable. The multiplication at the block 120 yields a steering wheel angle Thetaₛ which serves as the positive input to another summing point 122. The negative input to the summing point 122 is a pinion feedback angle Thetaₚ derived in part from the linear motion Xᵣ of the rack 90 at a terminal 124 described below. The summing point 122 yields an error angle Thetaₑ, which when multiplied by the stiffness Kₛ (at block 126) of the combined steering shaft 78 and torsion bar 52 connecting the steering wheel 12 to the pinion 54 gives the applied steering torque T (at terminal 116) that is substantially present anywhere along the steering shaft 78, input shaft 50 and at the pinion 54. Kₛ can be considered as a series gain element in this regard. T is fed back from terminal 116 for subtraction from Tₛ at the summing point 118 in the manner described above. Division of T by the pitch radius Rₚ of the pinion 54 at block 128 (or rather, multiplication by its reciprocal) gives the mechanical force Fₘ applied to the rack 90 via the pinion 54.

The total steering force Fₜ applied to the rack 90 is generated at summing point 130 and is the sum of the mechanical force Fₘ applied to the rack 90 via the pinion 54 and a hydraulic force Fₕ provided by the hydraulic assist of the particular system modeled by the block diagram 110. The hydraulic force Fₕ is derived from the applied steering torque T (again, supplied from terminal 116) in a manner described in more detail below. In any case, the hydraulic force Fₕ is summed with the mechanical force Fₘ at summing point 130 to yield the total force Fₜ in the manner indicated above.

Force applied to the effective steering linkage radius, Fᵣ, taken at terminal 132 is subtracted from the total force Fₜ at a summing point 134. The resulting algebraic sum (Fₜ−Fᵣ) from the summing point 134 is divided by (or rather, multiplied by the reciprocal of) a term (Mᵣs²+Bᵣs) at block 136, where Mᵣ relates to the mass of the rack 90 and Bᵣ is a parallel damping coefficient term associated with motion of the rack 90. The resulting product is the longitudinal motion Xᵣ of the rack 90 at terminal 124. Xᵣ is supplied as the positive input to a summing point 138, from which the lateral motion Xₕ of the steering gear housing 88 is subtracted. The algebraic sum (Xᵣ−Xₕ) taken at terminal 140 is divided by (or rather, multiplied by the reciprocal of) the pinion radius Rₚ at block 142 to yield a rotational feedback angle Thetaₚ which serves as the negative input to the summing point 122 as described above.

A time based derivative of the algebraic sum (Xᵣ−Xₕ) is taken at block 144 and then multiplied by power cylinder piston area A at block 146 to obtain a damping fluid flow Q_{d} which is supplied as a negative input to summing point 148. Concomitantly, the applied steering torque T present at terminal 116 is detected by the torque transducer 32 (at block 150) to obtain an applied torque signal Vₐₜ. The applied torque signal Vₐₜ is then multiplied by a control function constant K_{cf} at block 152 to obtain a control function signal V_{cf} that in turn is supplied as the positive input to summing point 154.

The fluid pressure P (e.g., that is present in the fluid line 18 and at the input slots 56 of the directional control open-center four-way valve 20) at terminal 156 is detected by the pressure transducer 34, which pressure transducer is represented at block 158, in order to obtain feedback pressure signal Vₚ which is then supplied as the negative input to summing point 154. The error signal Vₑ formed by the algebraic sum (V_{cf}−Vₚ) is filtered (which operation involves multiplying by the inverse of the instant servo valve gain as is preferably accomplished via software control means within the controller 30) at block 160 and amplified at block 162 to obtain a power control signal V_{c}. The power control signal V_{c} is then multiplied by the instant valve flow gain factor K_{q} (e.g., in accordance with the discussion relating to FIG. 5) at block 164 to obtain a controlled flow Q_{c} that in turn is supplied as the positive input to summing point 148. The algebraic sum (Q_{c}−Q_{d}) is next divided by (or rather, multiplied by the reciprocal of) an effective valve flow constant K_{c}[1+(Vₜs)/(4BₑK_{c},)] (e.g., indicative of the flow characteristics of the three-way valve 28) at block 166 to obtain the cylinder pressure P at terminal 156, where K_{c} is the valve flow constant, Vₜ is total cylinder volume and Bₑ is fluid bulk modulus. Finally, the cylinder pressure P is multiplied by the power cylinder piston area A at block 168 to obtain the hydraulic force Fₕ.

The lateral motion Xₕ of the steering gear housing 88 depends upon Fₜ. More particularly, Fₜ is a negative input to a summing point 170, from which a force F_{hsf} present at terminal 172 (e.g., applied to the steering assembly sub-frame 94 as a housing-to-sub-frame force) is subtracted. The lateral housing motion Xₕ is then determined by the product of the algebraic sum (−Fₜ−F_{hsf}) and a control element 1/(Mₕs²) at block 174, where Mₕ is the mass of the steering gear housing 88. Xₕ is taken from terminal 176 as the negative input to summing point 138 to yield the algebraic sum (Xᵣ−Xₕ) in the manner described above.

The output tire patch steering angle Thetaₜₚ at output terminal 114 is determined by tire patch torque Tₜₚ applied to the tire patches 178 (shown in FIG. 1) at terminal 180 multiplied by a control element 1/(BVₜₚs+Kₜₚ) shown at block 182, where Kₜₚ and Bₜₚ are tire patch torsional stiffness and damping coefficient terms, respectively. The tire patch torque Tₜₚ at terminal 180 is determined by the difference, achieved via summing point 184, between the average dirigible wheel angle Theta_{w} and the average output tire patch angle Thetaₜₚ multiplied by a control element (B_{sw}s+K_{sw}) shown at block 186, where K_{sw} and B_{sw} are torsional stiffness and torsional damping coefficients, respectively, associated with torsional deflection of tire side walls 188 (again shown in FIG. 1) with respect to the dirigible wheels 84. Theta_{w} is determined by the difference (achieved via summing point 190) between the torque T_{w} applied to the dirigible wheels 84 and the tire patch torques Tₜₚ, multiplied by a control element 1/(J_{w}s²) shown at block 192, where J_{w} is moment of inertia of the dirigible wheels 84.

The torque T_{w} applied to the dirigible wheels 84 is determined by the force Fᵣ applied at the effective steering linkage radius (located at terminal 132) multiplied by a control element R_{w} shown at block 194, where R_{w} is the effective steering linkage radius of the portion 108 of the steering knuckles 100 defined above. The force Fᵣ is determined in three steps. First, (f X_{sf}) is subtracted from Xᵣ at summing point 196 with (f X_{sf}) having been obtained by multiplying (at block 198) the lateral motion X_{sf} of the steering assembly sub-frame 94 present at terminal 200 by a coupling factor f between the steering assembly sub-frame 94 and mounting points 202 (shown in FIG. 1) for the lower control arms 106 and thus the dirigible wheels 84. Second, the product of Theta_{w} and R_{w} (obtained by multiplication at block 204) is subtracted from the algebraic sum (X_{f}−f X_{sf}) at summing point 206. Finally, this difference (Xᵣ−f X_{sf}−Theta_{w}R_{w}) is multiplied by a control element Kᵣ shown at block 208 to yield the rack forces Fᵣ at terminal 132, where Kᵣ is the stiffness of the connecting elements between the rack 90 and the dirigible wheels 84 (e.g., principally the stiffness of the portion 108 of the steering knuckles 100). Fᵣ is then returned to summing point 134 and the subsequent derivation of Xᵣ at terminal 124 is determined in the manner described above.

The balance of the block diagram 110 models the structural elements disposed in the path of reaction forces applied to the steering gear housing 88, and provides the lateral motion X_{sf} of the steering assembly sub-frame 94 (at terminal 200) and the housing-to-sub-frame force F_{hsf} (at terminal 172) mentioned above. Ultimately, the reaction force is applied to the mounting points 202 (at terminal 210) of the dirigible wheels 84 as a sub-frame reaction force F_{sf}. More particularly, F_{sf} is determined by the product of a control element (B_{sfmp}s+K_{sfmp}) shown at block 212 and X_{sf} at terminal 200, where K_{sfmp} and B_{sfmp} stiffness and series damping coefficient terms, respectively, associated with the interface between the steering assembly sub-frame 94 and the mounting points 202. X_{sf} at terminal 200 is determined by the product of control element 1/(M_{sf}S²+B_{sf}s) shown at block 214, where M_{sf} is the mass of the sub-frame as well as connected portions of the host vehicle's structure and B_{sf} is damping associated with coupling the steering assembly sub-frame 94 to the structure, and an algebraic sum (F_{hsf}−F_{sf}) generated by summing point 216, where F_{hsf} is the force applied to the steering assembly sub-frame 94 as the housing-to-sub-frame force located at terminal 172. F_{hsf} is determined by the product of a control element (B_{hsf}S+K_{hsf}) shown at block 218, where K_{hsf} and B_{hsf} are stiffness and damping terms associated with the interface between the steering gear housing 88 and the steering assembly sub-frame 94, and an algebraic sum (Xₕ−X_{sf}) generated by summing point 220. The positive input to summing point 220, Xₕ, is taken from terminal 176 while the negative input, X_{sf}, is taken from terminal 200.

The following values and units for the various constants and variables mentioned above can be considered exemplary for a typical power steering system, and a conventional host vehicle on which it is employed:
1/(Btps+Kₜₚ)=1/(20s+8,000)[rad./in.-lb.]
B_{sw}s+K_{sw}=30s+500,000[in.-lb./rad.]
1/(J_{w}s²)=1/(8s²)[rad./in.-lb.]
1/(Bₛs+Jₛs²)=1/(0.1s+0.5s²)[rad./in.-lb.]
R_{w}=5[in/rad.]
Kₖ=8,000[lb./in.]
1/(Mᵣs²+Bᵣs)=1/(0.02s²+0.1s)[in./lb.]
1/Rₚ=1/0.315[in.⁻¹]
K=500[in.-lb.]
f=0.7(dimensionless)
A=1.5[in.²]
1/(Mₕs²)=1/(0.05s²)[in./lb.]
B_{hsf}s+K_{hsf}=100s+150,000[lb/in.]
1/(B_{sf}s+M_{sf}s²)=1/(0.05s+0.4s²)[in./lb.]
B_{sfmp}s+K_{sfmp}=10s+20,000[lb.in.]
Vₜ=12[in.³]
Bₑ=100,000[lb./in.²]
K_{c}=0.1[in.⁵/lb.-sec.]
Pₗ, P_{c}, P_{d},=[lb./in.²]
X_{f}, Xₕ, X_{sf}, X_{f}=[in.]
F_{hsf}, Fₕ, F_{sff}, Fₜ, Fₘ, Fₕ, Fᵣ=[lb.]
T, Tₛ, Tₜₚ=[in.-lb.]
θₛ, θₑ, θₚ, θ_{w}, θₜₚ=[rad.]

It should be noted that the block diagram 110 is a minimal block diagram presented herein for enabling a basic understanding of dynamics of the accumulator enabled power steering system 10. In particular, a more complete representation would include various electronic resistance, electronic inductance, mass and stiffness elements associated with internal operation of the three-way valve 28. It is believed herein however, that these factors can be controlled in an inner feedback control loop separate from the overall feedback loop implemented with reference to the torque transducer. Preferably, the inner feedback control loop would be implemented with reference to the pressure signal Vₚ representative of actual fluid pressure values present in the fluid line 18 as provided by the pressure transducer 34. This type of control technique is described in detail in the incorporated '254 patent. In addition of course, pertinent servo valve design and control technologies are fully described in the book entitled “Hydraulic Control Systems.”

In passing however, it should be noted that functioning of the three-way valve 28 differs fundamentally from that of a common open-center control valve because the three-way valve 28 is fundamentally flow control device whereas open-center control valves are pressure control devices. In fact, their version of a gain constant K_{q}′ is actually a pressure gain constant with dramatically differing values that relate valve output pressures to input error angles. In any case, procedures for determining appropriate values for K_{q} and K_{c} as utilized herein are fully described in the book entitled “Hydraulic Control Systems.” On the other hand, procedures for determining appropriate values for K_{cf} over a range of input steering wheel torque and vehicle speed values are fully described in the incorporated '254 patent. Also, a description of procedures for evaluating stability criteria for power steering systems such as the accumulator enabled power steering system 10 as depicted in the block diagram 110 can be found in the incorporated '254 patent and so will not be repeated herein.

In addition, a possible problem wherein foam could form in the fluid due to rapid cycling of the steering wheel 12 should be addressed. This problem could arise due to pressure drop within either side of the double-acting power cylinder 16 relative to reservoir pressure. Such pressure drop could result from backflow through a respective one of the return orifices 72a and 72b of the directional control open-center four-way valve 20 when rapidly recovering from a turn. Although this problem could theoretically be solved by slightly pressurizing the reservoir 24, that possible solution is discounted herein because the reservoir 24 would likely have to be vented to the atmosphere in view of relatively large exchanges of fluid between the reservoir 24 and the accumulator 26 occurring during normal operation of the accumulator enabled power steering system 10. A more practical solution is to provide a pair of check valves 252 fluidly connected between the reservoir 24 and each of the left turn tube 22a and the right turn tube 22b as shown in FIG. 1.

Finally as depicted in the flow chart of FIG. 8, the present invention also includes a method for enabling an accumulator enabled power steering system comprising a steering wheel; an accumulator; a reservoir; a power steering gear comprising a double-acting power cylinder and a directional control open-center four-way valve operatively connected thereto; a three-way servo valve; a steering wheel torque transducer; a pressure transducer; and a controller to function in the manner of a force-based power steering system, wherein the method comprises the steps of: fluidly connecting an input port of the three-way servo valve to the accumulator; fluidly connecting an output port of the three-way servo valve to the pressure transducer and an input port of the directional control open-center four-way valve; measuring torque applied to the steering wheel and providing a signal representative of the magnitude thereof; determining and providing a signal representative of a desired pressure value to be applied to the input port of the directional control open-center four-way valve as a selected function of at least the applied torque value; measuring and providing a signal representative of the pressure value actually present at the input port of the directional control open-center four-way valve; subtracting the signal representative of the actual pressure value from the signal representative of the desired instant pressure value to form an error signal; filtering and amplifying the error signal to form a power control signal; and operating the three-way servo valve in response to the power control signal so as to continually reduce the error signal and thus provide the desired pressure value to the input port of the directional control open-center four-way valve.

Having described the invention, however, many modifications thereto will become immediately apparent to those skilled in the art to which it pertains, without deviation from the spirit of the invention. For instance, the three-way valve 28 could be formed with multiple holes defining input and return “ports” in place of the input grooves 40 and return grooves 44, thereby almost certainly lowering fabrication costs. Thus, such an over-lapped servo valve could, albeit with possibly some degradation of performance, be used in place of the three-way valve 28 having the input grooves 40 and return grooves 44 as depicted in FIG. 2. Such modifications clearly fall within the scope of the invention.

The instant system is capable of providing accumulator enabled power steering systems intended for medium through large vehicles, and accordingly finds industrial application both in America and abroad in power steering systems intended for such vehicles and other devices requiring large values of powered assist in response to torque applied to a steering wheel, or indeed, any control element functionally similar in nature to a steering wheel. Alphanumeric identifiers on method steps in the claims are for convenience in reference by dependent claims and do not signify a required order of performance of the method steps unless explicitly stated in the claims.

What is claimed is:

1. A power steering system for a vehicle comprising:
a pressurized fluid source;
at least one power cylinder;
a first valve operatively connected to the at least one power cylinder to control a steering direction; and
a second valve for controlling an amount of steering assist, the second valve having an input port fluidly connected to the pressurized fluid source and an output port fluidly connected to an input port of the first valve.

2. The power steering system of claim 1 wherein the first valve is mechanically coupled to a steering wheel.

3. The power steering system of claim 2 wherein the second valve is an electronically controlled valve.

4. The power steering system of claim 3 further including a controller selectively operating the second valve to control pressurized fluid delivered to the first valve.

5. The power steering system of claim 4 wherein the first valve is a four-way valve.

6. The power steering system of claim 5 further including a reservoir, the second valve including a return port fluidly connected to the reservoir.

7. The power steering system of claim 4 further including a pressure transducer for providing a pressure signal indicative of pressure values present at the input port of the first valve.

8. The power steering system of claim 7 wherein the controller provides a power control signal to the second valve based upon a difference between a control function signal and the pressure signal issued by the pressure transducer.

9. The power steering system of claim 7 wherein the first valve is an open center valve.

10. The power steering system of claim 1 wherein the at least one power cylinder is a double-acting power cylinder having a left input port and a right input port, the first valve fluidly coupled to the left input port and the right input port.

11. The power steering system of claim 10 wherein the first valve is mechanically coupled to a steering wheel and the second valve is an electronically controlled valve.

12. A method for operating a power steering system comprising
a) measuring applied torque on a steering wheel and providing a signal representative of the magnitude thereof;
b) determining and providing a signal representative of a desired pressure value to be applied to an input port of a directional control valve as a function of at least the applied torque;
c) measuring and providing a signal representative of an actual pressure value present at the input port of the directional control valve;
d) comparing the signal representative of the actual pressure value to the signal representative of the desired pressure value;
e) forming a power control signal based upon the comparison in said step d); and
f) controlling a supply of pressurized fluid to the input port of the directional control valve in response to the power control signal in order to provide the desired pressure value to the input port of the directional control valve.

13. The method of claim 12 further including the step of:
g) operating the directional control valve to supply the fluid from the input port of the directional control valve alternately to a left input port to steer the vehicle left and a right input port to steer the vehicle right.

14. The method of claim 13 wherein said step g) is performed by turning a steering wheel mechanically coupled to the directional control valve.

15. The method of claim 14 wherein the left input port and the right input port are input ports to a double-acting power cylinder.

16. The method of claim 12 wherein said step f) is performed by sending the power control signal to a valve connecting a pressurized fluid supply to the input port of the directional control valve.

17. The method of claim 12 wherein the supply of pressurized fluid is stored in an accumulator.

18. A power steering system for a vehicle comprising:
an accumulator;
a steering wheel;
a four-way valve for controlling a steering direction, the four-way valve mechanically coupled to the steering wheel, the four-way valve selectively fluidly connecting an input port to a left output port or a right output port for controlling steering direction; and
a three-way valve for controlling an amount of steering assist, the second valve having an input port fluidly connected to the accumulator and an output port fluidly connected to the input port of the four-way valve.

19. The power steering system of claim 18 wherein the three-way valve is an electronically controlled valve.

20. The power steering system of claim 19 further including a controller selectively operating the three-way valve to control pressurized fluid delivered to the four-way valve.

21. The power steering system of claim 20 wherein the first valve is a four-way valve.

22. The power steering system of claim 21 further including a reservoir, the three-way valve including a return port fluidly connected to the reservoir.

23. The power steering system of claim 18 further including a pressure transducer for providing a pressure signal indicative of pressure values present at the input port of the four-way valve.

24. The power steering system of claim 23 further including a controller providing a power control signal to the three-way valve based upon a comparison of a control function signal and the pressure signal issued by the pressure transducer.

25. The power steering system of claim 18 wherein the four-way valve is an open center valve.
